(19) United States
(12) Patent Application Publication
(10) Pub. No.: US 2012/0017486 A1
(43) Pub. Date: Jan. 26, 2012

(54) Firearm and Archery Sighting Device

(76) Inventor: James A. Jones, Black Rock, AR (US)

(21) Appl. No.: 13/185,612

(22) Filed: Jul. 19, 2011

Related U.S. Application Data
(60) Provisional application No. 61/366,237, filed on Jul. 21, 2010.

(51) Int. Cl. F41G 1/38; G01B 3/38; G01B 5/00; G01B 3/02; G01B 3/10

(52) U.S. Cl. 42/120

(57) ABSTRACT

A sighting device includes a sighting target having a generally planar piece of material with horizontal and vertical indicia that segment the material into four quadrants. Two upper quadrants are separated from two lower quadrants by the horizontal indicia and two left side quadrants are separated from two right side quadrants by the vertical indicia. The juncture of the horizontal and vertical indicia defines a bulls-eye, the bulls-eye also having indicia indicative of a target. The target may be included in a kit having various tools for measuring lateral and vertical distances between an actual impact point and the bulls-eye that indicate appropriate numbers of clicks to be made to a sighting scope mounted to a weapon such as a rifle, compound bow, or crossbow.

### CROSS REFERENCE TO RELATED APPLICATION

This non-provisional patent application claims the benefit of provisional application Ser. No. 61/366,237 filed on Jul. 21, 2010, titled “Firearm and Archery Sighting Device.”

### BACKGROUND OF THE INVENTION

This invention relates generally to sighting devices, and more particularly to a sighting device for calibration of a scope attached to a rifle, compound bow, or crossbow so as to properly align the scope crosshairs or dot to the projectile's impact point on the target at which the scope and hunting device is aimed.

In 2004, there were 14,283,920 deer hunters in the United States according to the Deer Hunters Almanac. Of these, 11,100,287 were gun hunters and 3,183,643 were archery hunters. One reason that more deer hunters do not use compound bow or crossbows may be the relative complexity of bow hunting equipment as compared to gun hunting equipment. Another reason most deer hunters prefer to use guns is that shots taken with bows often miss their targets, resulting in lost arrows or wounded (not killed) game. Rifles with scopes however, when properly sighted in have been a more efficient means of killing the animal being hunted. Sighting the scope on rifles, compound bows, and crossbows during hunting or sighting in these weapons prior to an actual hunt can be a difficult endeavor

Various devices have been proposed in the art for aiding a hunter in sighting or targeting a hunted animal. Sighting accessories may be mounted to a rifle or crossbow and to the frame or strings of a compound bow for use by the hunter. Rifles, crossbows, and compound bows and, more particularly, their targeting scopes, may be “sighted in” by adjusting windage and elevation settings such that the hunter can achieve greater accuracy during a hunt although this is often a trial and error task. Once properly sighted, however, the hunter has confidence that he will hit whatever he is aiming at when he pulls the trigger or releases his arrow. Although the prior devices and proposals are assumably effective for their intended purposes, the existing devices do not provide a virtually guaranteed means for targeting and hitting a deer unless the device is properly sighted in.

Paper targets were created to give the hunter a target to aim and shoot at, providing a point of aim (bulls-eye) and enough width and length so that when he is aiming at the target bulls-eye, shoots and misses, he sees where the projectile has struck the target. He then has to correctly calculate the distance from where he was aiming to where the projectile struck the target to properly align the scope settings to the projectile's impact point on the target.

Targets come with different targeting designs, some with grid patterns representing one inch measurements and other designs for shooting game. Mechanical and laser bore sighting devices were created to aid the hunter to represent the direction the projectile will travel to the intended target, but does not give the actual terms of measurement, relative to the settings stated by the scope manufacturer. Specifically, the windage and elevation setting adjustments for the scope, when being adjusted, “click” when being adjusted. The scope manufacturer's specifications for sighting in will refer to each “click” sound being a unit of measurement which moves the crosshairs or dot to align with the projectiles impact point.

Once the hunter calculates the distance between the bulls-eye being aimed at and the projectiles impact point, he has to divide that distance by the “click” terms of measurement provided by the scope manufacturer. When this calculation is correctly completed and adjustments made to the scope windage and elevation settings, the scope sights will be properly aligned to the projectile's impact point.

Therefore it would be desirable to have a sighting device and method for use with a rifle, compound bow and a crossbow that visually identifies and calculates the exact units or “clicks” of measurement specified by the scope manufacturer, to align the scope crosshairs or dot to the projectile's impact point.

### SUMMARY OF THE INVENTION

A sighting device according to a preferred embodiment of the present invention includes a sighting target having a generally planar piece of material with horizontal and vertical indicia that divide the material into four quadrants. Two upper quadrants are separated from two lower quadrants by the horizontal indicia and two left side quadrants are separated from two right side quadrants by the vertical indicia. The juncture of the channels defines a bulls-eye, the bulls-eye also having indicia indicative of a target. The target may be included in a kit having various tools for measuring lateral and vertical distances between an actual impact area and the bulls-eye that indicate appropriate numbers of clicks to be made to a sighting scope mounted to a weapon such as a rifle, compound bow, or crossbow.

Therefore, a general object of the present invention is to provide a sighting device and method that produces a visual indication and calculation of the distance between where a hunter is aiming a rifle, compound bow, or crossbow and the actual impact point of a projectile being fired therefrom.

Another object of the present invention is to provide a sighting device and method, as aforesaid, that is associated with the scope manufacturer's specifications of a relative distance that one “click” represents on a shooting target.

Still another object of the present invention is to provide a sighting device and method, as aforesaid, that facilitate a visual calculation of the exact number of “click” adjustments to adjust elevation settings to projectile impact point.

Yet another object of the present invention is to provide a sighting device and method, as aforesaid, that facilitate a visual calculation of the exact number of “click” adjustments to adjust windage settings to projectile impact point.

A further object of the present invention is to provide a sighting device and method, as aforesaid, that facilitates a visual calculation of the exact number of “click” adjustments to adjust elevation settings simultaneously to the projectile impact point

A particular object of the present invention is to provide a sighting device and method, as aforesaid, that facilitates a visual calculation the exact number of “click” adjustments to adjust elevation and windage settings to projectile impact point by using a retractable tape housed in a compact unit that can be stored in a jacket or pants pocket.

Yet another object of the present invention is to provide a sighting device and method, as aforesaid, that facilitates a visual calculation the exact number of “click” adjustments to adjust elevation and windage settings to projectile impact point by using an electronic measuring device.

Other objects and advantages of the present invention will become apparent from the following description tacked in connection with the accompanying drawings, wherein is set forth by way of illustration and example, embodiments of this invention

### BRIEF DESCRIPTION OF THE DRAWINGS

FIG. 1 is a perspective view of a target sighting device according to a preferred embodiment of the present invention;

FIG. 2 is a square adapted for use in a kit including the target of FIG. 1;

FIG. 3 is a ruler adapted for use in a kit including the target of FIG. 1;

FIG. 4 is a retractable tape measure adapted for use in a kit including the target of FIG. 1;

FIG. 5 is a digital caliper device adapted for use in a kit including the target of FIG. 1;

FIG. 6 is a perspective view of a traditional sighting scope for use with the present invention; and

FIG. 7 is a perspective view of the target sighting device illustrating a hypothetical impact point by a bullet or arrow while sighting the head.

### DESCRIPTION OF THE PREFERRED EMBODIMENT

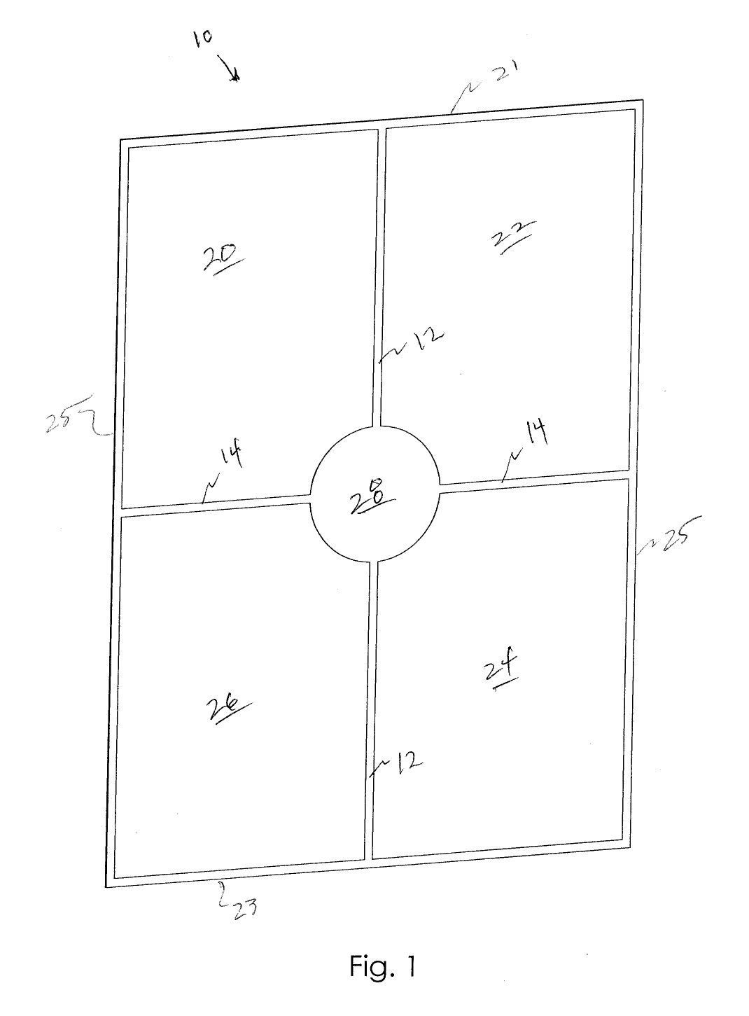

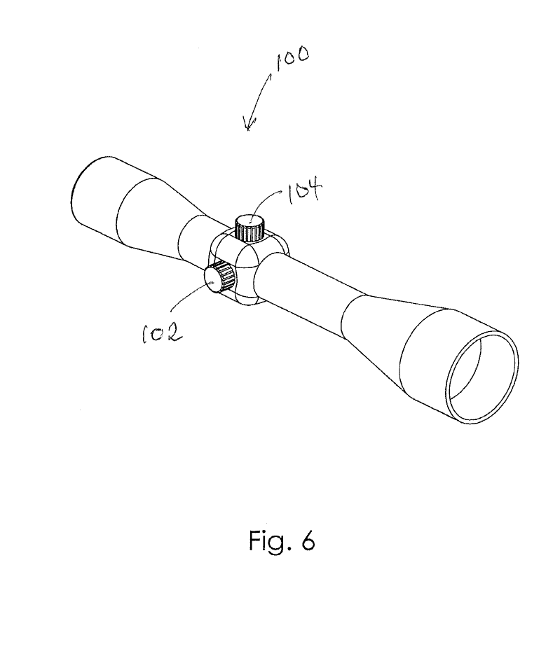

A sighting device according to a preferred embodiment of the present invention will now be described with reference to FIGS. 1 to 7 of the accompanying drawings. The sighting target 10 includes a generally planar piece of material having opposed upper 21 and lower 23 edges and opposed side edges 25 peripherally connecting the upper 21 and lower 23 edges (FIG. 1). The sighting target 10 further includes a vertical divider indicia 12 that is situated midway between the opposed side edges and extends between upper 21 and lower 23 edges. A horizontal divider indicia 14 is situated on the sighting target 10 midway between the upper 21 and lower 23 edges and extends between side edges 25. Together, the vertical 12 and horizontal 14 indicia divide the material into four quadrants. Preferably, the sighting target 10 is constructed of a paper material having a thick mill cardboard backing. For reference purposes, the quadrants may be referred to as upper left 20, upper right 24, lower right 24, and lower left 26 quadrants. It is understood that each quadrant is separated from any other quadrant by both a portion of a respective horizontal and vertical divider indicia.

At the juncture/intersection of the horizontal 14 and vertical 12 divider indicia as well as convergence of all four quadrants, an “ideal impact zone” or “bulls-eye” 28 may be imprinted. The bulls-eye represents the position on the target that indicates, if struck by a bullet or arrow during a sighting shot, that the scope is sighted in and need not be further adjusted for windage or elevation. Additional indicia (not shown), such as a circle or a plurality of concentric circles arranged radially about the juncture between horizontal 14 and vertical 12 channels may also be imprinted to designate the bulls-eye and points close to it.

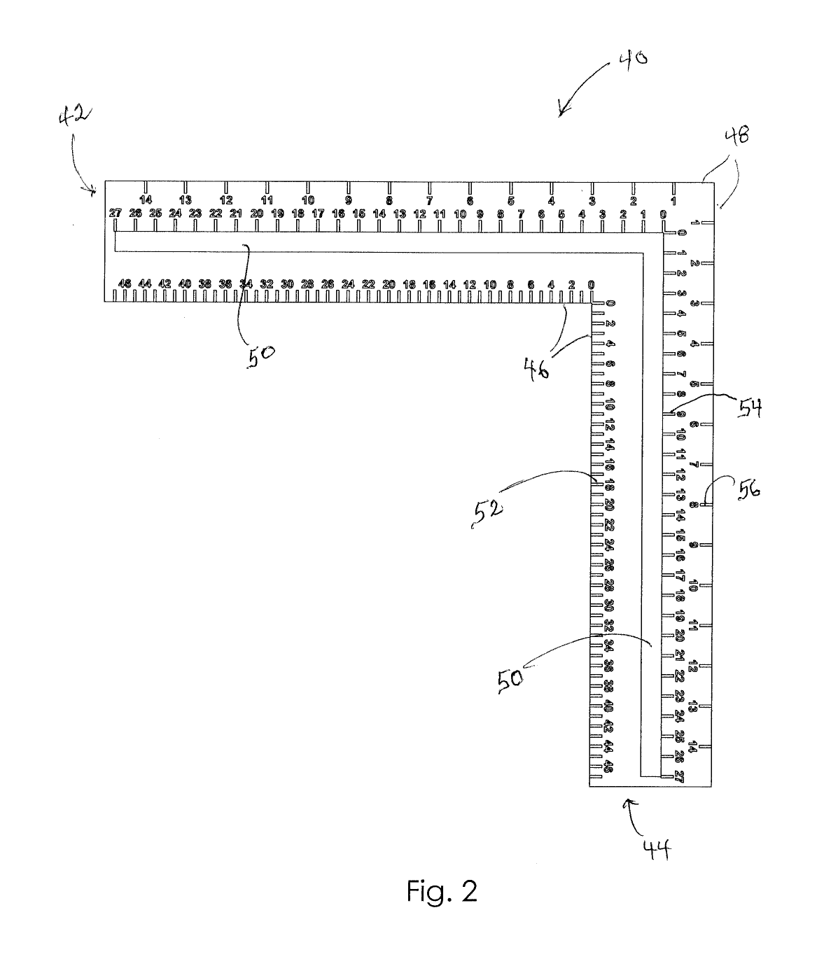

The preferred embodiment of the present invention may include one or more specialized measuring devices for inclusion as a kit for use with the target 10. One such measuring device includes a measuring square 40 having a construction similar to a traditional builder's square except as specifically described below. More particularly, the measuring square 40 includes a first section 42 coupled to a second section 44 situated at a 90 degree angle relative to the second section such that the two sections are perpendicular and at a right angle to one another (FIG. 2). The first section 42 may also be referred to as a generally horizontal section and the second section 44 may be referred to a generally vertical section as this a typical orientation of the square in use. First 42 and second 44 sections include inner 46 and outer 48 edges extending longitudinally between respective opposed ends (which may also be referred to as “free” ends). Each of the first 42 and second 44 sections include a generally planar configuration that define a linear channel 50 through the planar surfaces and that extends substantially between free ends of the first 42 and second 44 sections. The channel 50 may also be referred to as a first section channel and a second section channel that are operatively connected. The channel 50 serves essentially as a window through which a user may be able to identify the center of the bulls-eye as well as a horizontal or vertical point on either the horizontal indicia 14 or vertical indicia 12 that is perpendicular to an impact point within a respective quadrant after a test shot has been made, as will be described in more detail later.

Preferably, the measuring square 40 includes indicia representing one or more measuring scales, each associating a predetermined distance with a number of clicks of a scope in order to properly adjust a windage or elevation adjustment member so that a next targeting shot will hit the target bulls-eye. Each scale is based on a targeting shot being made from a predetermined distance from the target, such as 50 yards or 100 yards. For example, a first scale 52 (measurement/tick marks and numeric indicia) nearest the inner edge 46 may be associated with the condition of sighting a scope at 100 yards from the target and the number of clicks per ⅛ inch increment on the target. For example, a distance of ⅛″ between measurement marks may require adjustment of one “click” of a respective scope elevation or windage adjustment member 104. A second scale 56 adjacent the outer edge 48 may be associated with the condition of sighting a scope at 100 yards from the target and the number of clicks per ½ inch increment on the target. Still further, a third scale 54 may be situated along the channel 50 and intermediate the first and second scales 52, 54 that is associated with the condition of sighting a scope at 100 yards from the target and number of clicks per ¼ inch increments on the target. Preferably, every scale on a respective measuring square would be associated with a targeting shot being made from the same distance. In other words, a separate square is provided for targeting from 25 yards, 50 yards, 100 yards, etc. It is understood that the measuring indicia on the vertical section may be associated with adjustment of the windage adjustment whereas the measuring indicia on the horizontal section may be associated with adjustment of the elevation adjustment member. It is also understood that the distance between measurement marks of each scale is different from the distance between marks of each other scale.

With further regard to the scales provided on each square 40, each scale is based on an equation determined by a manufacturer's specification, it being appreciated that one of the three scales is likely to be associated with virtually any and every scope currently being sold. In other words, different scopes use one of the scales represented herein (e.g. ⅛″, ¼″, ½″). Accordingly, a user just needs to know which scale is appropriate for the scope being sighted and then utilize an appropriate square to adjust the sighting buttons on a scope 100 as indicated at an appropriate tick mark on the chosen square.

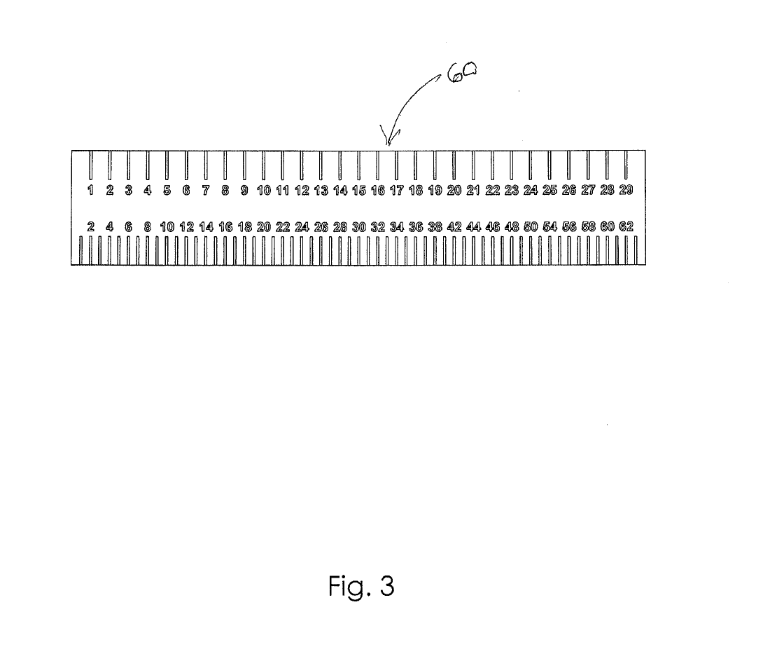

It is contemplated that the measuring square 40 may be supplemented or substituted by one or more rulers 60 also having one or more scale indicia that has been predetermined according to a manufacturer's specifications for a particular scope at a predetermined distance (e.g. 100 yards) (FIG. 3). An appropriate scale indicia on a ruler would be used to measure a distance between the bulls-eye and a point on a respective horizontal or vertical divider line perpendicular to an impact point so as to determine the number of clicks of a respective elevation or windage scope adjustment member. Upon making the indicated adjustments, a next targeting shot would be expected to hit the bulls-eye.

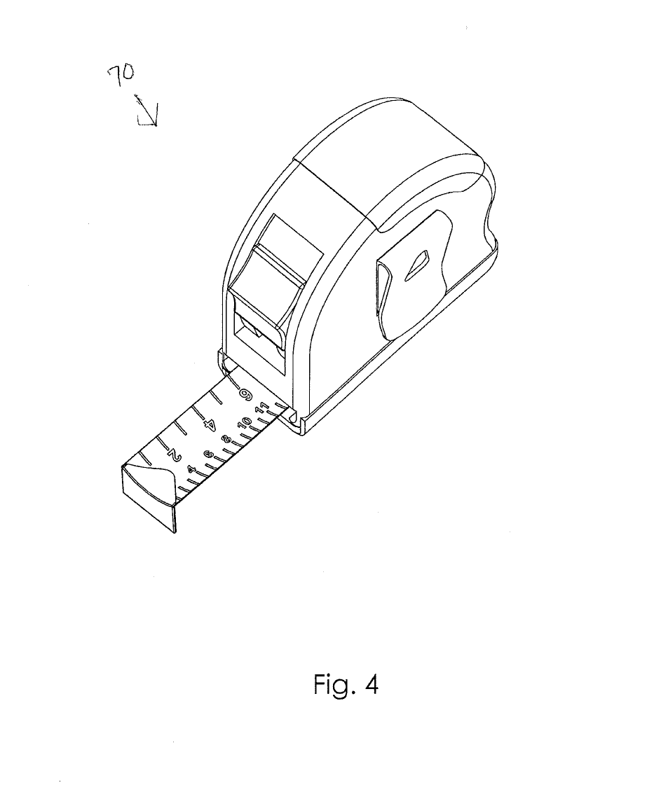

Another measuring device that may be included in a kit of the present invention is a retractable measuring tape 70 (FIG. 4). The measuring tape 70 includes a construction substantially similar to that of the ruler described above but includes a flexible base material.

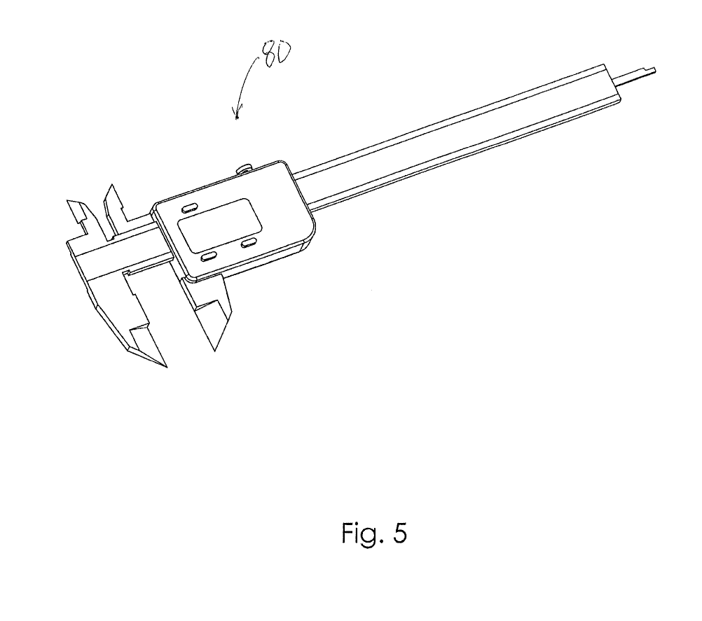

Still another measuring device that may be included in a kit of the present invention is an electronic measurement device such as an electronic caliper device 80 that may or may not employ a laser beam (FIG. 5). The electronic caliper device may include slidable features and a display that visually indicates a distance from the bulls-eye to a point (laterally or vertically) perpendicular to an actual impact area. The caliper device 80 may include a processor that automatically translates a distance into the number of adjustment clicks needed to appropriately adjust the scope and then display the number on an electronic display screen.

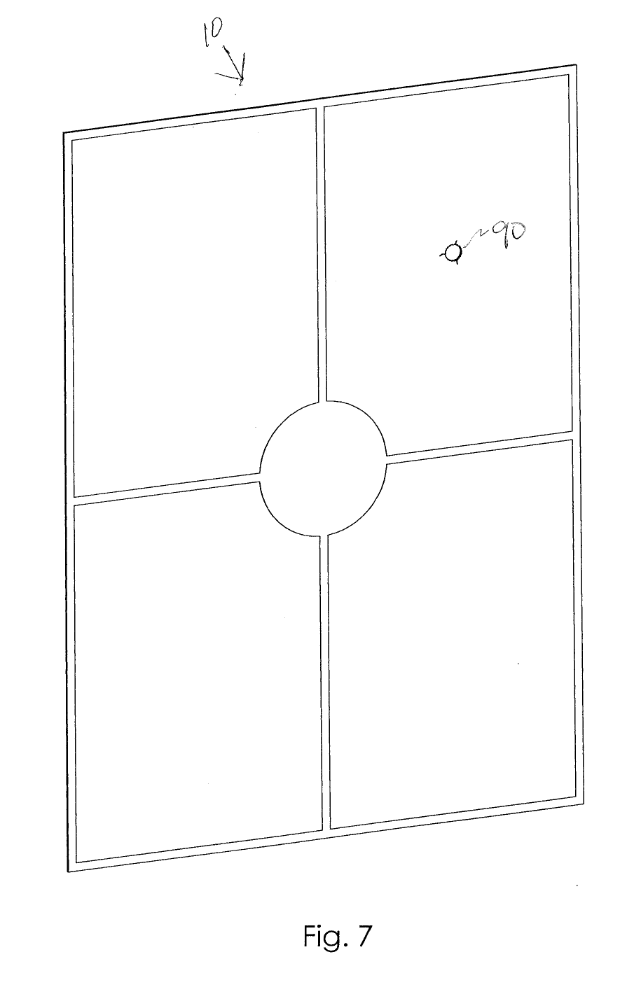

In use, a target 10 is positioned at a desired distance, say, 25, 50, or 100 yards from where a targeting shot will be taken. This distance will be according to a scope manufacturer's specifications. Then, a shooter of a rifle, compound bow, or crossbow may aim and actuate/fire the respective shooting device (i.e. a hunting weapon) at the target 10 from the appropriate distance, being careful to use the weapon's scope to aim at the bulls-eye of the target 10. After taking a shot, the shooter may retrieve and/or examine the target 10 and identify which quadrant thereof the shot impacted (FIG. 7) (also referred to as “the impact point 90”). The shooter must then determine the distance that the impact point is to the right or left of the bulls-eye 28 and above or below the bulls-eye 28. One of the measuring devices described above may be used to measure the distance that the impact point is right/left and above/below the bulls-eye. Using the scale on the measuring device corresponding with the distance between the shooter and the target, it may be determined how many clicks of the elevation and windage adjustment members need to be manipulated in order that a next targeting shot will hit the bulls-eye. Once adjusted the scope may be relied upon in accurately sighting an animal when hunting.

It is understood that while certain forms of this invention have been illustrated and described, it is not limited thereto except insofar as such limitations are included in the following claims and allowable functional equivalents thereof.

1. A sighting kit for use in sighting in a scope having adjustable windage and elevation members, comprising:
a sighting target having a generally planar configuration, opposed upper and lower edges and opposed side edges connecting said upper and lower edges, said sighting target further including:
a vertical divider indicia situated midway between said opposed side edges and extending between said upper and lower edges;
a horizontal divider indicia situated midway between said upper and lower edges and extending between said opposed side edges;
a bulls-eye indicia situated at an intersection of said vertical and horizontal divider indicia;
wherein said vertical and horizontal indicia divide said sighting target into four equal quadrants;
a first measuring device including a first section having opposed ends with opposed inner and outer edges extending longitudinally between said opposed ends, said first measuring device further including:
a first scale positioned adjacent said first section inner edge having a plurality of measurement marks spaced apart a first predetermined distance from one another, said first predetermined distance being associated with an amount the windage and elevation adjustment members, respectively, must be adjusted to sight in said scope.

2. The sighting kit as in claim 1, wherein said first section of said first measuring device includes a second scale positioned adjacent said first section outer edge having a plurality of measurement marks spaced apart a second predetermined distance from one another, said second predetermined distance being different than said first predetermined distance.

3. The sighting kit as in claim 2, wherein said first section includes a third scale positioned intermediate said first and second scales and having a plurality of measurement marks spaced apart a third predetermined distance from one another, said third predetermined distance being different than said first and second predetermined distances.

4. The sighting kits as in claim 2, wherein said first section of said measuring device defines a first section channel situated between said first and second scales and extending substantially between said first measuring device opposed ends

5. The sighting kit as in claim 1, wherein said first section defines a first section channel situated between said first section inner and outer edges and extending substantially between said first section opposed ends.

6. The sighting kit as in claim 1, wherein said first measuring device includes a second section coupled to said first section and oriented perpendicular to said first section such that together said first and second sections form an L-shaped configuration.

7. The sighting kit as in claim 6, wherein said second section includes the same measurement indicia as said first section.

8. The sighting kit as in claim 7, wherein said second section defines a second section channel operatively connected to said first section channel.

9. The sighting kit as in claim 1, wherein said first measuring device is one of a ruler, a flexible measuring tape, or a caliper device.

10. A method for sighting in a hunting scope having adjustable windage and elevation members and that is mounted to a shooting device, said method including the steps:
providing a sighting target having horizontal and vertical divider indicia configured to define four quadrants;
providing a first measuring device that includes a first section having opposed ends with opposed inner and outer edges extending longitudinally between said opposed ends;
wherein said first measuring device includes a first scale positioned adjacent said first section inner edge and having a plurality of measurement marks spaced apart a first predetermined distance from one another, said first predetermined distance being associated with an amount the windage and elevation adjustment members, respectively, must be adjusted to sight in said scope;
aiming the hunting scope at an intersection of said horizontal and vertical divider indicia on said sighting target;
actuating the shooting device to shoot a projectile toward said intersection on said sighting target;
determining an impact point where said projectile impacted said sighting target;
positioning said first measuring device on said sighting target with a respective end thereof on said intersection of said vertical and horizontal indicia;
measuring from said first scale a distance from said intersection to said impact point;
associating from said measured distance a quantity of adjustments to make to the elevation and windage members of the scope.

11. The method of claim 10, further comprising the step of retrieving and examining said sighting target after the step of actuating the shooting device.

12. The method of claim 10, wherein said first section includes a second scale positioned adjacent said first section outer edge and having a plurality of measurement marks spaced apart a second predetermined distance from one another, said second predetermined distance being different than said first predetermined distance.

13. The method as in claim 12, wherein said first section includes a third scale positioned intermediate said first and second scales and having a plurality of measurement marks spaced apart a third predetermined distance from one another, said third predetermined distance being different than said first and second predetermined distances.

14. The method as in claim 10, wherein said first section of said measuring device defines a first section channel situated between said first and second scales and extending substantially between said first measuring device opposed ends.

15. The method as in claim 10, wherein said first measuring device includes a second section coupled to said first section and oriented perpendicular to said first section such that together said first and second sections form an L-shaped configuration.

16. The method as in claim 15, wherein:
said step of measuring from said first scale a distance from said intersection to said impact point includes the step of measuring a horizontal distance from said intersection to said impact point and the step of measuring a vertical distance from said intersection to said impact point; and
said step of associating from said measured distance includes the step of associating from said measured horizontal and vertical distances a quantity of adjustments to make to the elevation and windage members, respectively, of the scope.

17. The method of claim 16, wherein said second section includes the same measurement indicia as said first section.

18. The method of claim 17, wherein said second section defines a section channel operatively connected to said first section channel.

19. The method of claim 18, wherein said first measuring device is one of a ruler, a flexible measuring tape, or a caliper device.
